(19) United States
(12) Patent Application Publication
(10) Pub. No.: US 2008/0037563 A1
(43) Pub. Date: Feb. 14, 2008

(54) Method and apparatus for automatically detecting and configuring service ports of an optical network terminal (ONT)

(76) Inventor: Marc R. Bernard, Miramar, FL (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 11/503,396

(22) Filed: Aug. 10, 2006

(51) Int. Cl. H04L 12/56

(52) U.S. Cl. 370/401; 370/252

(57) ABSTRACT

A method and corresponding apparatus is provided for automatically configuring a Network Interface Device (NID). The NID enables automatic detection of communications on multiple service ports. When the NID detects communications, it configures at least one of the multiple service ports and informs the supervisory unit of the service port(s) on which communications are detected. The NID may configure at least one of the multiple service ports by disabling the multiple service ports except the service port(s) on which communications are detected. The NID may subsequently detect inactivity and re-enable automatic detection of communications. The NID may activate a timer that times when to inform the supervisory unit, to configure service ports, or to re-enable automatic detection of communications. Embodiments of the invention reduce the time and effort required to install a NID, e.g., an ONT, especially when an installer does not initially know the best service port(s) to use.

### RELATED APPLICATION

This application claims the benefit of U.S. Provisional Application, entitled “Method and Apparatus for Automatically Detecting and Configuring Service Ports of an Optical Network Terminal (ONT)”, by Marc R. Bernard, filed on Aug. 10, 2006. The entire teachings of the above application are incorporated herein by reference.

### BACKGROUND OF THE INVENTION

When a technician or end-user initially installs an Optical Network Terminal (ONT), she may not know the best ONT service port(s) to connect to an end-user's Local Area Network (LAN). For example, the technician may not initially know whether it is easier and faster to install category 5 cable and use the ONT's Ethernet port or to use the end-user's existing coaxial (“coax”) cabling network and use the ONT's Multimedia over Coax Alliance (MOCA) port. A service provider may also configure a specific communications service on the ONT in response to an end-user request; however, the configured communications service may be deemed impractical by the technician. In such a case, the technician must call the Network Operations Center (NOC) and ask a co-worker to activate another service port or the technician must activate another service port via a remote hand held device. This extra step, however, takes up valuable time and may introduce errors.

### SUMMARY OF THE INVENTION

A method and corresponding apparatus to automatically detect and configure a Network Interface Device (NID), such as an Optical Network Terminal (ONT), in accordance with an embodiment of the present invention is provided. An example embodiment includes: (1) enabling automatic detection of communications on at least one of multiple service ports of the NID, (2) configuring at least one of the multiple service ports based on a detection of communications, and (3) informing a supervisory unit external from the NID of at least one of the multiple service ports on which the communications are detected.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a network diagram of a communications network employing an example embodiment of the present invention;

FIG. 2 is a network diagram of a Passive Optical Network (PON) employing another example embodiment of the present invention;

FIG. 3 is a network block diagram of exemplary elements of a PON configured to automatically configure a Network Interface Device (NID);

FIG. 4 is a network block diagram of exemplary elements of another PON in accordance with example embodiments of the present invention;

FIG. 5 is a network block diagram of exemplary elements of another PON in accordance with example embodiments of the present invention;

FIG. 6 is a flow diagram illustrating an example embodiment of the present invention;

FIGS. 7 and 8 are flow diagrams illustrating other example embodiments of the present invention incorporating timers;

FIG. 9 is a flow diagram illustrating a manner by which detection of communications is re-enabled; and

FIG. 10 is a flow diagram illustrating an example embodiment incorporating a timer in conjunction with re-enabling detection of communications.

### DETAILED DESCRIPTION OF THE INVENTION

A description of example embodiments of the invention follows.

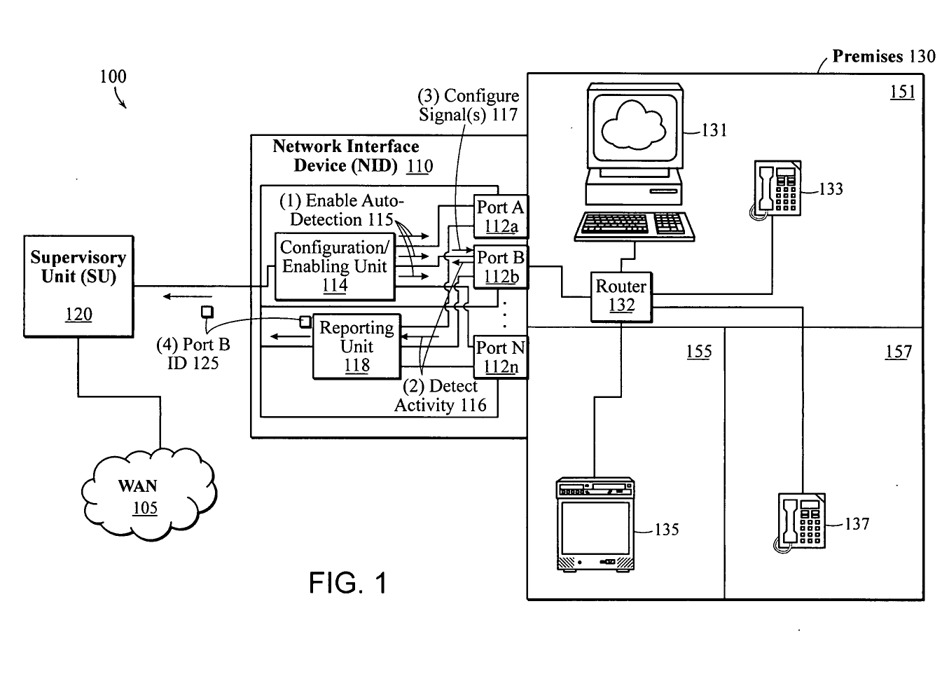

FIG. 1 is a network block diagram of a communications network 100, such as an optical communications network, that includes a Supervisory Unit (SU) 120 and Network Interface Device (NID) 110 in communication with each other. The NID 110 includes a plurality of ports 112a-n (Port A, Port B, . . . , Port N), an enabling unit 114, and a reporting unit 118. A router 132 located in a premises 130 may connect to the NID 110, for example, via Port B 112b. The SU 120 may connect to a Wide Area Network (WAN) 105 and provide communications services to the NID 110. The communications services may be provided to various end-user devices located at the premises 130. Example end-user devices include a computer 131, telephones 133, 137, and an audio-visual device 135. As illustrated, these end-user devices may be located in different rooms 151, 155, 157 of the premises 130 and may connect to the NID 110 via the router 132.

Example embodiments of the present invention may operate according to multiple modes. Three example modes are presented herein for illustration purposes. In all modes, the enabling unit 114 may enable automatic detection of communications on Ports A-N 112a-n by transmitting an enable auto-detection signal 115 to Ports A-N 112a-n. In some embodiments, the enabling unit 114 may enable automatic detection of communications on a selected number of Ports A-N 112a-n. When the router 132 is connected to Port B 112b, Port B 112b may detect communications activity between it and the router 132. In response to detecting communications activity, Port B 112b may transmit a detect activity signal 116 to the reporting unit 118. The reporting unit 118, in turn, may inform the SU 120 that communications have been detected on Port B 112b via a Port B ID message 125. The NID 110 may then configure Port B 112b so that it is enabled or maintains an enabled state.

In a first mode (“mode 1”), the ports at which communications are not detected (e.g., Port A 112a, Port C 112c, . . . , Port N 112n) are permanently disabled. In a second mode (“mode 2”), the ports at which communications activity is not detected (e.g., Port A 112a, Port C 112c, . . . , Port N 112n) are temporarily disabled. When inactivity is later detected at the port where communications activity was previously detected (e.g., Port B 112b), the enabling unit 114 may re-enable automatic detection of communications on Ports A-N 112a-n by transmitting another enable auto-detection signal 115 to Ports A-N 112a-n. Subsequently, the same (e.g., Port B 112b) or a different port (e.g., Port A 112a) may detect communications activity between it and the router 132 and cause the reporting unit 118 to inform the SU 120 that communications have been detected on that port.

In a third mode (“mode 3”), the ports at which communications activity is not detected (e.g., Port A 112a, Port C 112c, . . . , Port N 112n) are never disabled. Therefore, anytime any port detects communications activity between it and the router 132, the reporting unit 118 informs the SU 120 that communications have been detected on that port. The NID 110 may include a timer that times when (1) to inform the SU 120, (2) to disable the ports at which communications activity is not detected, or (3) to re-enable automatic detection of communications activity.

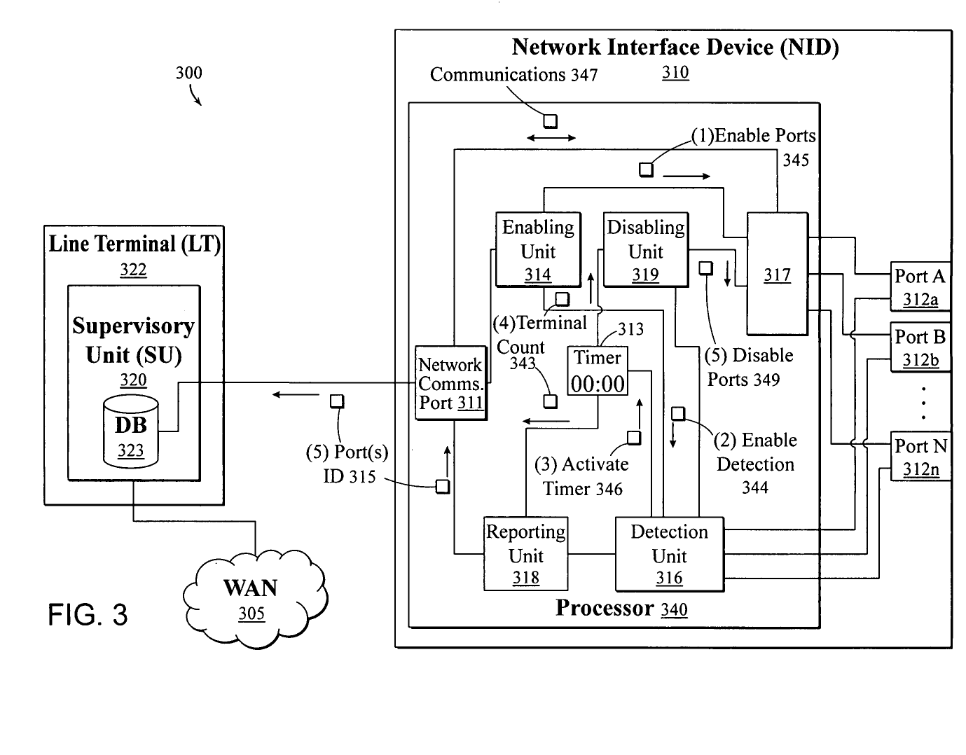

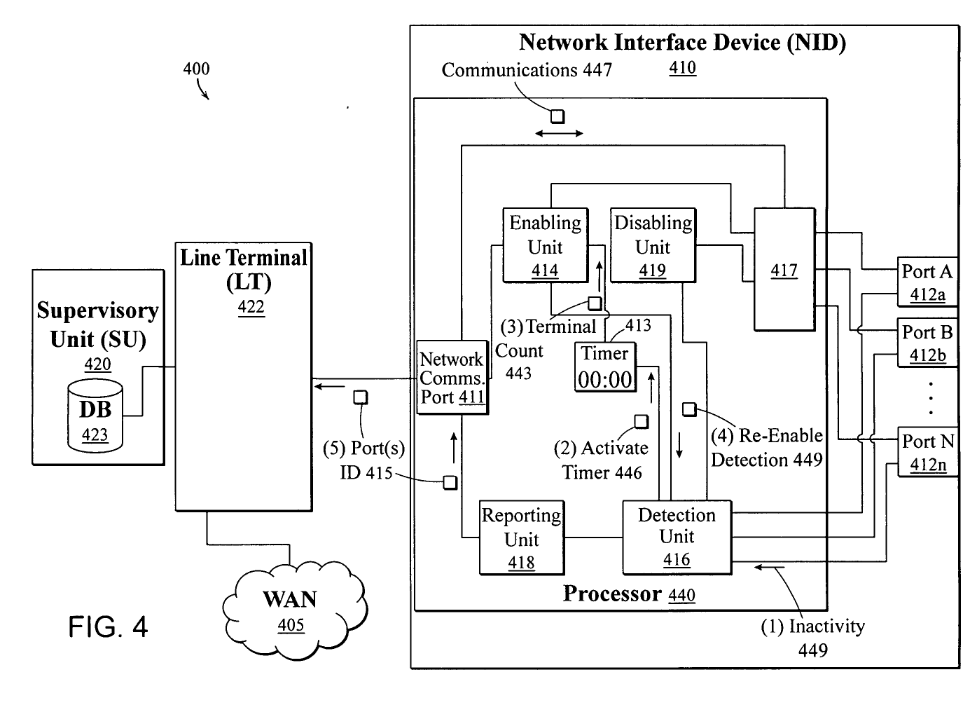

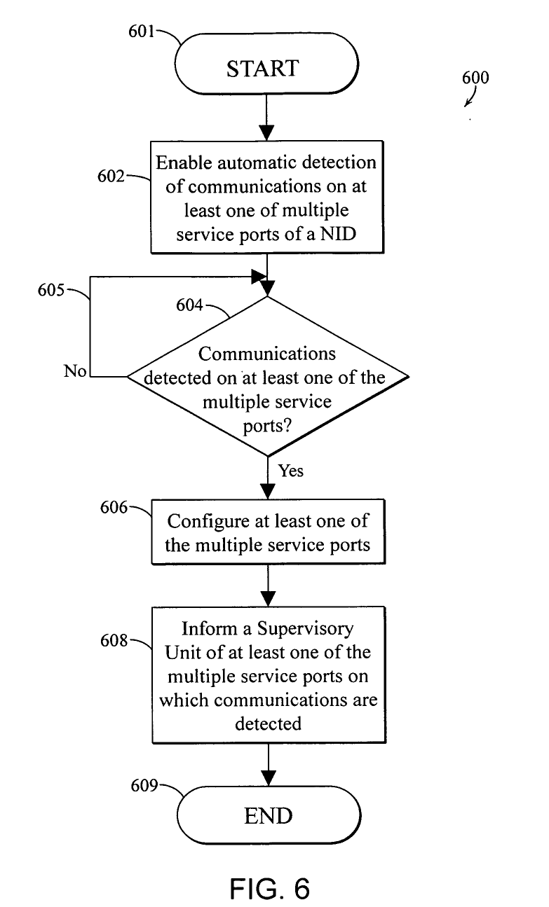

FIGS. 1 and 6 illustrate embodiments that are common to modes 1-3. FIGS. 3, 7, and 8 illustrate mode 1. FIGS. 4, 9, and 10 illustrate mode 2.

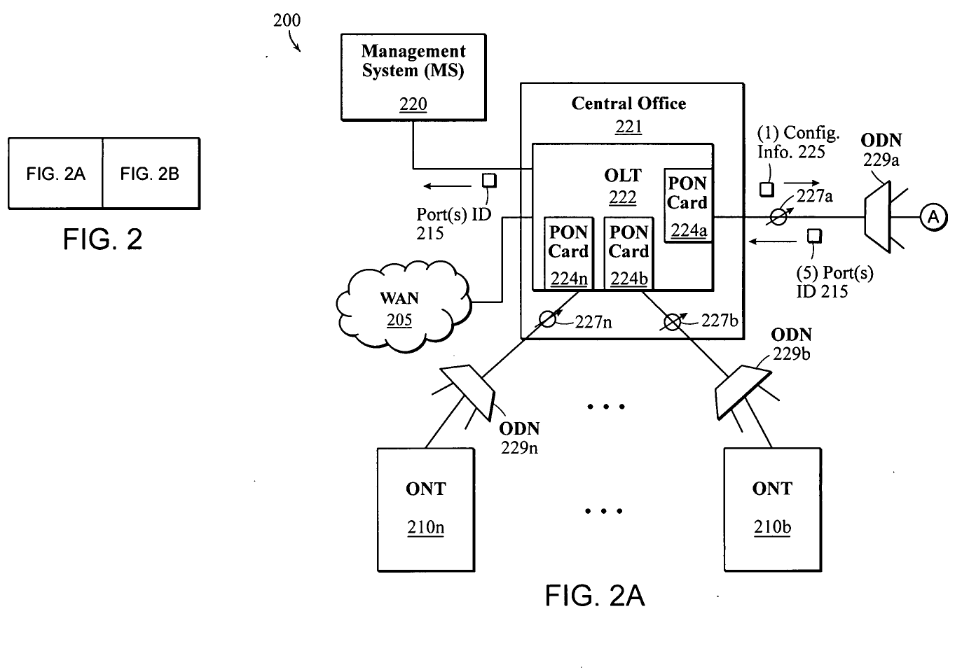

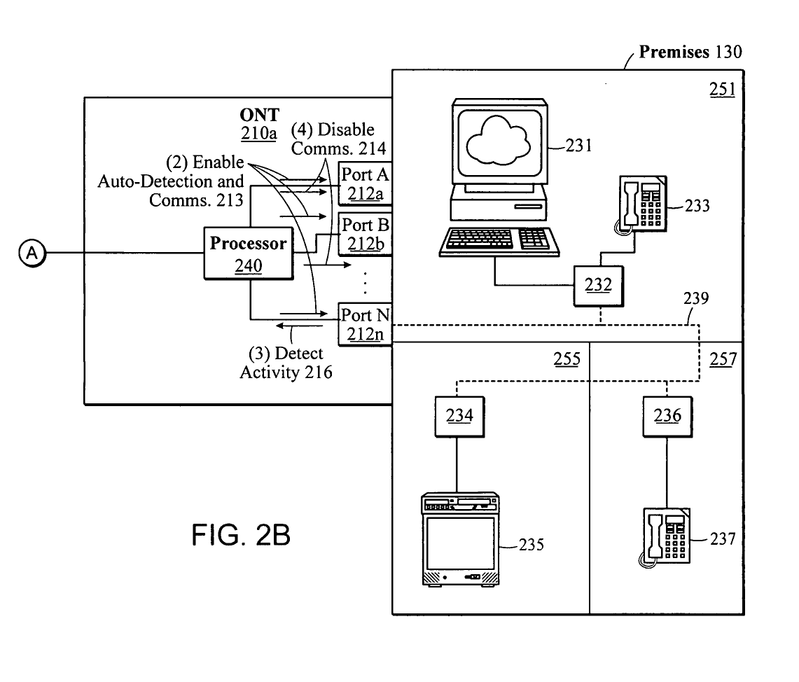

FIG. 2 is a network diagram of an example Passive Optical Network (PON) 200 employing an embodiment of the present invention. The PON 200 includes multiple Optical Network Terminals (ONTs) 210a-n connected to an Optical Line Terminal (OLT) 222 located at a Central Office 221. The ONTs 210a-n may connect to respective PON cards 224a-n disposed in the OLT 222 via respective optical links 227a-n and Optical Distribution Networks 229a-n. A Management System (MS) 220 connects to the OLT 222 to manage the elements of the PON 200. Each ONT 210a-n may include multiple ports. For example, ONT 210a may include Ports A-N 212a-n. Ports A-N 212a-n may support technologies such as Ethernet, Wi-Fi, Very-high-bit-rate Digital Subscriber Line (VDSL), Home Phone Line Networking Alliance (HPNA), Home Plug Power Line Alliance, Multi-media over Coax Alliance (MoCA), wireless, and other home network solutions.

Typically, when an end-user desires to purchase communications services, he may contact a service provider and request the communications services. The service provider may then dispatch a technician to the end-user's premises 230 to install the ONT 210a or to set up communications services on an already installed ONT. Before or after the technician installs the ONT 210a, the service provider may provision the ONT 210a with configuration information including the serial number of the ONT 210a and a setting to enable a default communications service or a specific communications service based on information known to the service provider or provided by the end-user. For example, the service provider may use the management system 220 to configure the ONT 210a with a default communications service, such as Ethernet service.

Nonetheless, the service provider, technician, or ONT installer may not be certain as to the preferred and/or fastest way to connect the ONT 210a to the end-user's Local Area Network (LAN). For example, the service provider or technician may initially determine that it is best to install a category 5 cable and to use the ONT's Ethernet port (e.g., port B 212b). After arriving at the end-user's premises 230, however, the technician may determine that the configured Ethernet service is impractical for the premises 230. The technician may suggest to the end-user that she take advantage of a more practical technology provided on another port of the ONT 210a. The technician, for example, may suggest that it would be best to connect existing telephone wiring 239 of the premises 230 to Port N, which supports HPNA technology. A computer 231 and a first telephone 233 in a first room 251, an audiovisual device 235 in a second room 255, and a telephone 237 in a third room 257 may connect to port N 212n through respective HPNA adapters 232, 234, 236, such as HPNA USB, PC Card or Internal PCI card adapters. Alternatively, the technician may suggest that it would be best to connect an existing coaxial (“coax”) cabling network to Port A, which supports MoCA technology.

In order to reconfigure the communications services of the ONT 210a from Ethernet to HPNA, the technician must call the Network Operations Center (NOC) and request that another co-worker remotely activate Port N 212n, which is the HPNA port. The technician may alternatively reconfigure ONT 210a using a remote hand held device via flow through provisioning. Then, the technician must wait until the ONT 210a is reconfigured and an ONT 210a database is updated, before reinstalling the ONT 210a. However, these extra steps take up valuable time and may introduce additional errors. As an alternative, service providers have given end-users the ability to log into the ONT 210a or a router to access a web page or a management interface and to activate a desired port (e.g., Port N 212n). However, the end-user must expend extra effort, and the end-user may “hack” into the ONT 210a.

In an embodiment of the present invention, the technician or an end-user may install the ONT 210a in the end-user's premises 230 with communications services disabled on all the service ports 212a-n. After the technician boots up the ONT 210a and connects the ONT to the PON 200 to communicate with the OLT 222, the ONT 210a ranges with the OLT 222. Under the direction of the MS 220, the OLT 222 then sends to the ONT 210a its configuration information 225, including the provisioning for its service ports 212a-n. The configuration information of the ONT 210a may include a setting to enable automatic detection of communications on all service ports 212a-n. Once the ONT 210a receives its configuration information, it activates the service ports 212a-n by, for example, transmitting an enable communications signal 213 to the service ports 212a-n, which allows the service ports 212a-n to communicate with the end-user devices 231, 233, 235, 237 in the premises 230. The ONT 210a also enables automatic detection of communications at the service ports 212a-n by, for example, transmitting an enable auto-detection signal 213 to the service ports 212a-n.

When Port N 212n or the processor 240 automatically detects a communications connection between Port N 212n and the existing telephone wire 239 of the premises 230, the processor 240 may execute a variety of tasks. The processor 240 may disable the other ports (e.g., Ports A and B 212a and 212b) via a disable communications signal 214 and update the ONT's 210a configuration information. The processor 240 may disable the other ports by powering them down to conserve battery power in case of power loss. For example, a Plain Old Telephone System (POTS) port uses a significant amount of power when it is powered up. If an end-user device is not connected to the POTS port, the processor 240 may power down the POTS port to conserve battery power during a power loss. The processor 240 may also send a Port(s) ID signal 215 to the management system 220 via PON card 224a identifying Port N 212n as the port that is active or has been provisioned.

Thus, the automatic detection or automatic sensing feature of an example embodiment of the ONT 210a eliminates extra steps and time that would otherwise be required to reconfigure the ONT 210a with another service port. As a result, the more than five hours required for installing a single ONT, for example, may be reduced by about 30-60 minutes.

FIG. 3 is a network block diagram of exemplary elements of a network 300 configured to automatically configure a Network Interface Device (NID). The NID 310, such as an ONT, includes an enabling unit 314, a disabling unit 319, an interface 317, a timer 313, a reporting unit 318, a detection unit 316, a network communications port 311, and multiple service ports 312a-n (Ports A-N). Any combination of the enabling unit 314, the disabling unit 319, the interface 317, the reporting unit 318, the detection unit 316, or the timer 313 may be implemented as hardware, firmware, software modules in a processor 340. The detection unit 316 may be configured to detect communications automatically on one or more of the service ports 312a-n, and the enabling unit 314 may be configured to enable the detection unit 316 to detect communications automatically.

The NID 310 connects to a Supervisory Unit (SU) 320 located at an Line Terminal (LT) 322, such as an OLT. The LT 322, in turn, connects to a Wide Area Network (WAN) 305. In operation, the SU 320, which may be external from the NID 310, may first send configuration information to the NID 310 via the network communications port 311. The configuration information may cause the enabling unit 314 to enable the service ports 312a-n. For example, in response to the configuration information from the LT 322, the enabling unit 314 may send an enable ports signal 345 to the interface 317 to enable ports 312a-n to communicate with an end-user network (not shown).

Also, in response to configuration information from the supervisory unit 320, the enabling unit 314 may enable the detection unit 316 to detect communications automatically on one or more of the ports 312a-n by sending an enable detection signal 344. When the detection unit 316 detects communications activity on one or more of ports 312a-n, the detection unit 316 starts the timer 313 via an activate timer signal 346. The timer 313 may be a countdown or count up timer that times a duration defined by a terminal count 343. In one embodiment, the duration may be several hours, such as eight hours. After timer 313 reaches the terminal count 343, the reporting unit 318 informs the SU 320 of the one or more service ports 312a-n on which communications activity is detected by the detection unit 316. For example, the reporting unit 318 may send a port(s) identifier message 315 to the SU 320 via the network communications port 311.

In one embodiment, the disabling unit 319 may disable all the service ports 312a-n except the one or more service ports on which communications are detected by the detection unit 316, after the timer 313 reaches the terminal count 343. For example, the disabling unit 319 may provide a disable ports signal 349 to the interface 317 that causes the interface 317 to disable all but the one or more of the service ports 312a-n on which communications are detected. The timer 313 may provide an opportunity for a technician or end-user to change service ports before the disabling unit 319 disables the service ports on which communications is not detected by the detection unit 316.

In other embodiments, the disabling unit 319 may disable communications services on the service ports on which communications is not detected by the detection unit 316 immediately after the detection unit 316 detects communications on one or more of the ports 312a-n. Thus, one or more of ports 312a-n may be automatically and immediately configured when a technician or end-user connects to one or more ports 312a-n. The reporting unit 318 may then inform the SU 320 of one or more of the service ports 312a-n on which communications are detected by the detection unit 316 by, for example, sending a port(s) ID message 315 to the SU 320 via the network communications port 311.

FIG. 4 is a network block diagram of exemplary elements of another network 400 in accordance with embodiments of the present invention. The network 400 includes a Network Interface Device (NID) 410 connected to a Line Terminal LT 422. The LT 422 in turn connects to a Supervisory Unit (SU) 420 and a Wide Area Network (WAN) 405. The SU 420 includes a database 423 that stores configuration information of the NID 410 and other NIDs (not shown) connected to the LT 422. The NID 410 includes a processor 440 and multiple service ports 412a-n. The processor 440 may include an enabling unit 414, a disabling unit 419, a reporting unit 418, a detection unit 416, an interface 417, and a network communications port 411. The reporting unit 418 may communicate with the SU 420 via the network communications port 411 using an existing communications protocol between the SU 420 and the NID 410.

In one embodiment, the detection unit 416 connects to Ports A-N 412a-n to monitor for inactivity on one or more of Ports A-N 412a-n. When the detection unit 416 detects communications inactivity 449 on one or more of Ports A-N 412a-n that were previously enabled, it causes the enabling unit 414 to re-enable the detection unit 416 to detect communications automatically on one or more of the Ports A-N 412a-n. The enabling unit 414 may also send a re-enable ports signal to the interface 417 to activate the Ports A-N 412a-n. When the detection unit 416 detects communications activity on one or more of Ports A-N 412a-n, the reporting unit informs the SU 420 of the one or more Ports A-N 412a-n on which communications activity are detected by the detection unit 416. For example, the reporting unit 418 may send a port(s) identifier message 415 to the SU 420 via the network communications port 411 and the LT 422.

This embodiment allows a technician or an end-user to disconnect a Local Area Network (LAN) from a service port and reconnect to another service port without requiring the Network Operations Center (NOC) or technician to remotely activate the desired port. In another embodiment, the timer 413 may be in communication with the detection unit 416 so that the detection unit 416 may activate the timer 446 after detecting inactivity on enabled service ports connected to an end-user network (not shown). When the timer 413 reaches a terminal count 443, the enabling unit 414 may re-enable the service ports 412a-n by causing interface 417 to enable ports A-N 412a-n to communicate with an end-user network (not shown). The enabling unit 414 also re-enables detection of communications 449 by the detection unit 416. When the detection unit 416 detects communications activity on one or more of ports A-N, the reporting unit 418 may send a signal 415, such as a command or message, to the SU 420 indicating the one or more service ports A-N 412a-n on which communications are detected by the detection unit 416. The information contained in signal 415 may be stored in the database 423 of SU 420.

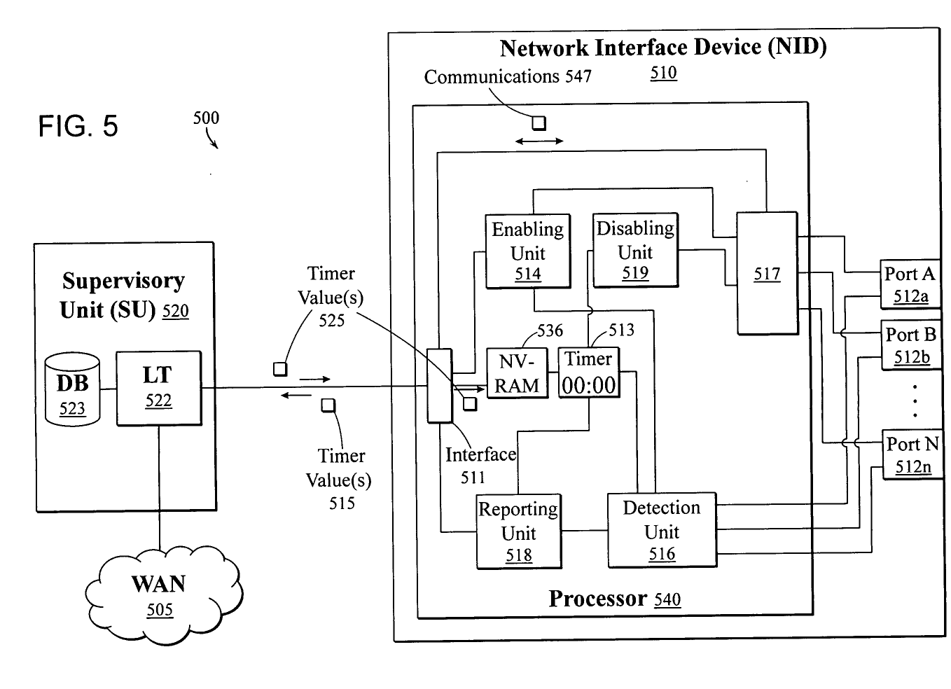

FIG. 5 is a network block diagram of elements of another exemplary network 500 in accordance with embodiments of the present invention. A NID 510 includes service ports A-N 512a-n and a processor 540. The processor 540 includes a first interface 511, a timer 513, an enabling unit 514, a detection unit 516, a second interface 517, a reporting unit 518, and non-volatile memory 536, such as Non-Volatile Random Access Memory (NVRAM). A supervisory unit (SU) 520 may provision the NID 510 with timer values 525 that define the terminal counts of the timer depending on the particular uses of the timer 513 described in above embodiments. The timer values 525 may be stored in the non-volatile memory 536. In an alternative embodiment, a technician or end-user may update the non-volatile memory 536 with timer values 515 and the reporting unit 518 may inform the SU 520 of the timer values 515. The SU 520 may then store the timer values 515 in the database 523.

One of the timer values 515 may correspond to a length of time sufficient to install the NID 510 in a network. For example, one of the timer values may be used by the timer 513 to provide a length of time between detecting communications at the detection unit 516 and informing the SU 520 by the reporting unit 518. Other timer values may correspond to a duration of time during which the detection unit 516 must detect communications activity or inactivity on at least one of the service ports 512a-n before the timer 513 may respectively cause the disabling unit 519 to disable the service port(s) on which communications are not detected or may cause the enabling unit 514 to re-enable automatic detection of communications. The SU 520 may include an LT 522 which maintains communication with a Wide Area Network (WAN) 505.

FIG. 6 is an example flow diagram 600 illustrating an embodiment of the present invention. After starting (601), a Network Interface Device (NID) first enables automatic detection of communications (602) on at least one of multiple service ports of the NID. Next, the NID monitors for communications (604, 605) on at least one of the NID's multiple service ports. When the NID detects communications on at least one of the multiple service ports, it configures (606) at least one of the multiple service ports. For example, the NID may configure the service port(s) on which communications are detected with specific communications services, such as data and voice, and default settings for these communications services. In addition to configuring at least one of the multiple service ports, the NID informs a Supervisory Unit (SU) (608) of at least one of the multiple service ports on which communications are detected. Otherwise (609), the NID continues to monitor for communications activity on at least one of the multiple service ports. The flow diagram 600 then ends (609).

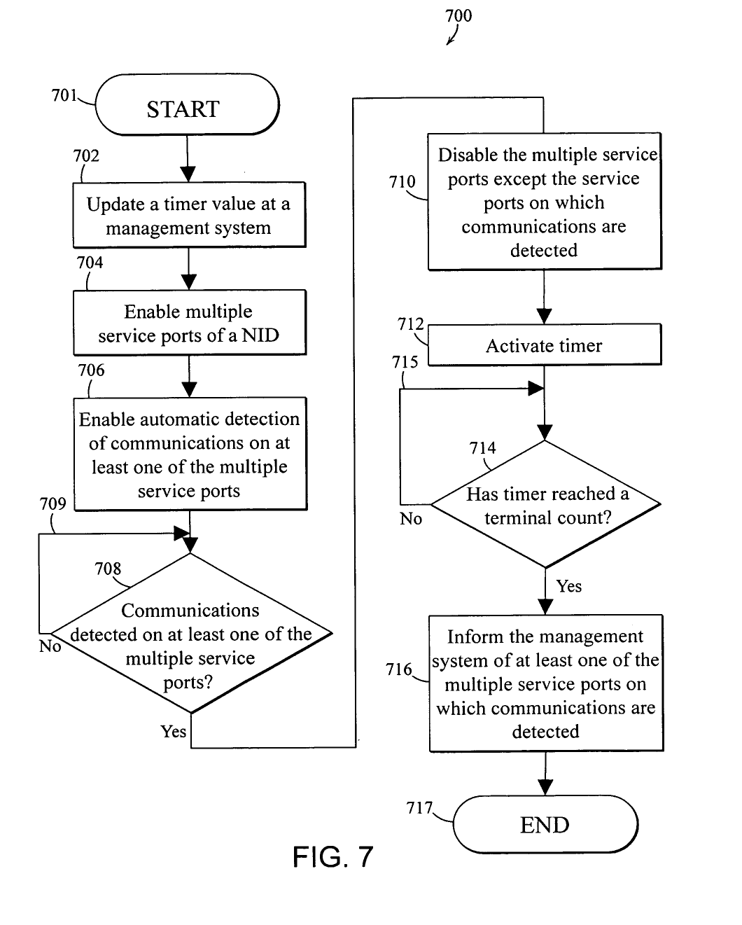

FIG. 7 is an example flow diagram 700 illustrating another embodiment in which the service ports on which communications are not detected are disabled (i.e., mode 1). After starting (701), a NID updates a timer value (702) at a management system. The timer value may correspond to a length of time sufficient to install the NID in a network. The NID then enables the NID's multiple service ports (704) and enables automatic detection of communications (706) on at least one of the multiple service ports.

The NID subsequently monitors for communications (708, 709) on at least one of the multiple service ports. A technician installing the NID may determine that a specific communications service is practical and may connect an end-user's LAN to the appropriate service port. If the NID detects communications on at least one of the multiple service ports, the NID may configure at least one of the multiple service ports by, among other actions, disabling the multiple service ports (710) except the service port(s) on which communications are detected. The NID may also activate a timer (712) (e.g., enable the counting down of the timer), such as an auto-sense installation timer. After activating the timer, the NID monitors whether the timer has reached a terminal count (714, 715). If the timer reaches the terminal count (e.g., the timer expires), and before ending (719), the NID informs the management system (718) of at least one of the multiple service ports on which communications are detected.

The management system may then update its permanent database with this configuration information from the NID. This ensures that the NID maintains this configuration information at all times and prevents the end-user from attempting to access the other service ports (e.g., data service ports) on the NID. From this point forward, for example, if an ONT loses ranging because of loss of power, fiber-break, upgrade, and so forth, the ONT may disable all service ports and re-range with an OLT. When the ONT re-ranges with the OLT, the OLT may send configuration information or parameters to the ONT, including configuration information stored in an OLT permanent database to re-enable the previously enabled service ports (i.e., the service ports on which communications were previously detected).

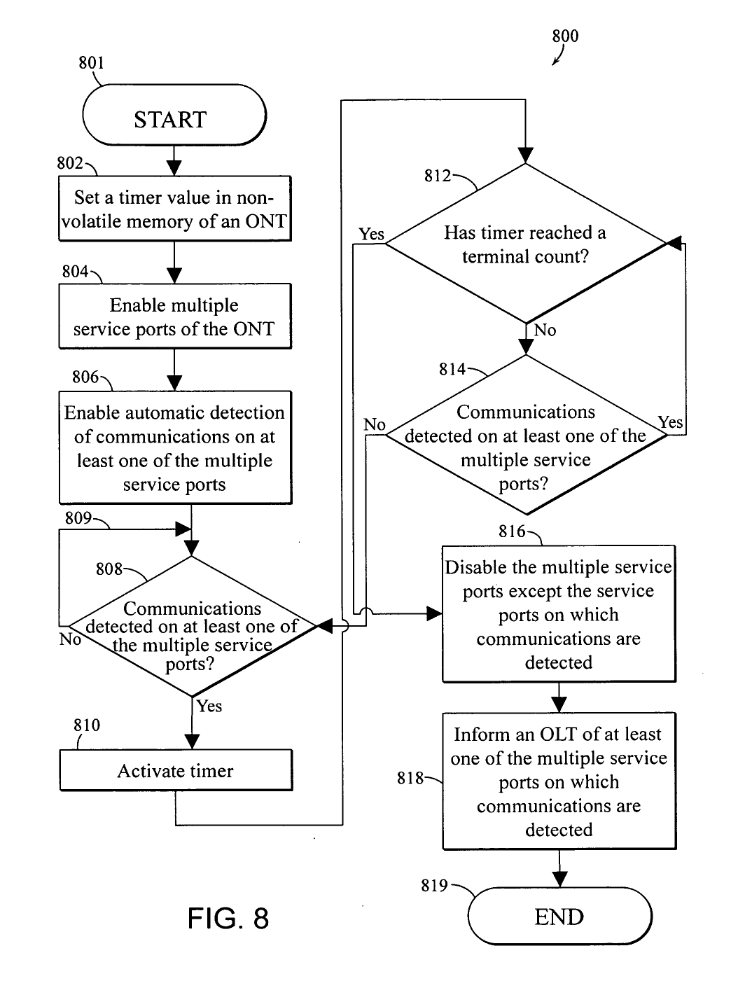

FIG. 8 is an example flow diagram 800 illustrating another embodiment incorporating a timer. After starting (801), a supervisory unit may set a timer value (802) in non-volatile memory of an Optical Network Terminal (ONT). The ONT then enables multiple service ports (804) of the ONT and enables automatic detection of communications (806) on at least one of the multiple service ports. The NID may support a hysteresis behavior in which the NID disables the multiple service ports only after the NID detects communications on at least one of the multiple service ports for a given duration of time. Accordingly, when the ONT detects communications (808) on at least one of the multiple service ports, it activates a timer (810). Otherwise (809), the ONT continues to monitor for communications on at least one of the multiple service ports.

After the ONT activates the timer (810), it continually monitors whether the timer has reached a terminal count (812) and whether communications continue to be detected (814) on at least one of the multiple service ports. If communications are not detected on at least one of the multiple service ports before the timer reaches a terminal count, then the timer may reset and the ONT may again monitor for communications (808, 809) on at least one of the multiple service ports. If the timer reaches a terminal count, the ONT disables (816) the multiple service ports except the service ports on which communications are detected and informs an OLT (818) of at least one of the multiple service ports on which communications are detected. The flow diagram then ends (819).

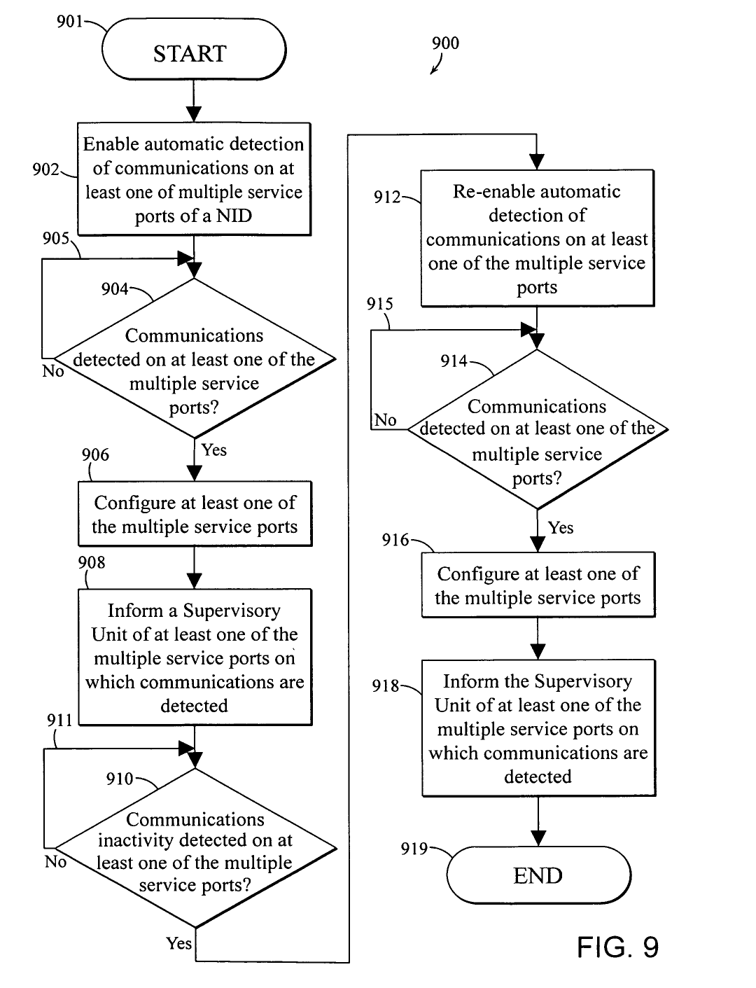

FIG. 9 is an example flow diagram 900 illustrating a manner by which automatic detection of communications are re-enabled according to another embodiment (i.e., mode 2). After starting (901), automatic detection of communications is enabled (902) on at least one of multiple service ports of a NID. The NID then monitors for communications (904, 905) on at least one of the multiple service ports. If communications are detected on at least one of the multiple service ports, then at least one of the multiple service ports are configured (906). In addition, a supervisory unit is informed (908) of at least one of the multiple service ports on which communications are detected.

Next, the NID may monitor for inactivity (910, 911) on the at least one of the multiple service ports on which communications were previously detected. If the NID detects inactivity, it re-enables automatic detection of communications (912) on at least one of the multiple service ports. This may occur when a technician disconnects an end-user's LAN from a NID service port after she determines that it is better or more practical to use another service port. Next, the NID again monitors for communications (914, 915) on at least one of the multiple service ports. Before ending (919), if the NID detects communications, it configures (916) at least one of the multiple service ports and informs a supervisory unit (918) of at least one of the multiple service ports on which communications are detected.

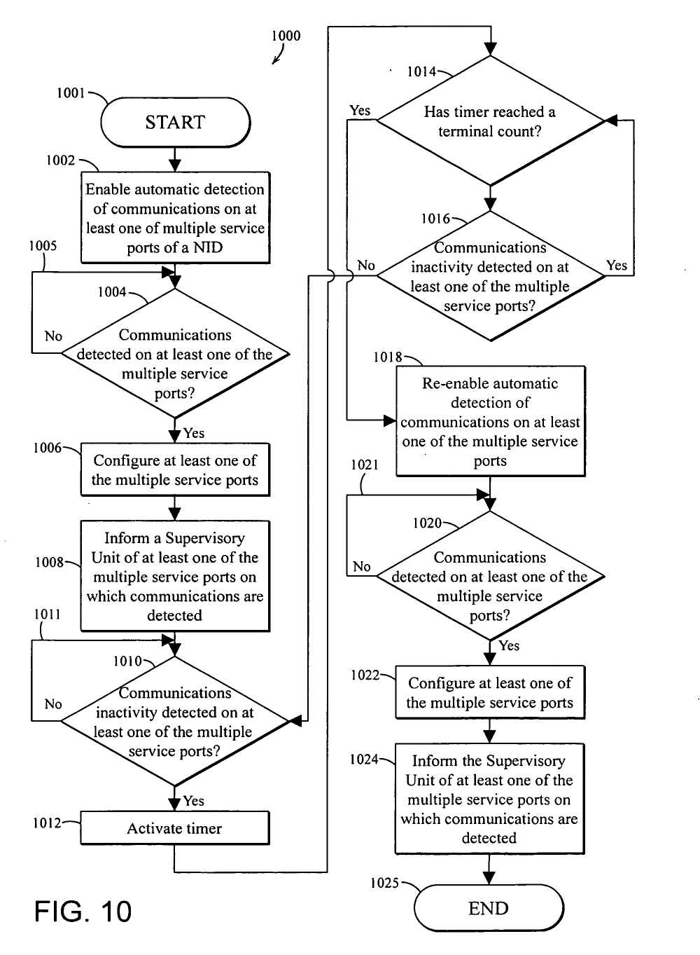

FIG. 10 is an example flow diagram 1000 illustrating use of a timer in conjunction with re-enabling detection of communications on multiple service ports of a NID. After starting (1001), automatic detection of communications is enabled (1002) on at least one of multiple service ports of a NID. The NID then monitors for communications (1004, 1005) on at least one of the multiple service ports. If communications are detected on at least one of the multiple service ports, then at least one of the multiple service ports are configured (1006) and a supervisory unit is informed (1008) of at least one of the multiple service ports on which communications are detected.

The NID may support a hysteresis behavior in which the NID re-enables automatic detection of communications on at least one of the multiple service ports only after the NID detects inactivity on at least one of the multiple service ports on which communications were previously detected for a given duration of time. The example flow diagram 1000 implements this hysteresis behavior as follows. When the NID detects inactivity (1010) on at least one of the multiple service ports, it activates a timer (1012). Otherwise (1011), the NID monitors for communications on at least one of the multiple service ports.

After the NID activates the timer (1012), it continually monitors whether the timer has reached a terminal count (1014) and whether inactivity is detected (1016) on at least one of the multiple service ports. If inactivity is not detected on at least one of the multiple service ports before the timer reaches a terminal count, then the timer may reset and the ONT may again monitor for inactivity (1010, 1011) on at least one of the multiple service ports. If the timer reaches a terminal count, the NID again monitors for communications (1020, 1021) on at least one of the multiple service ports. If it detects communications, it configures (1022) at least one of the multiple service ports and informs the supervisory unit (1024), via a network communications port and an existing protocol between the supervisory unit and the NID, of at least one of the multiple service ports on which communications are detected. The flow diagram then ends 1023.

While this invention has been particularly shown and described with references to example embodiments thereof, it will be understood by those skilled in the art that various changes in form and details may be made therein without departing from the scope of the invention encompassed by the appended claims.

It should be understood that any of the above-described flow diagrams of FIGS. 6-10 or underlying methods used to implement aspects related to the networks of FIGS. 1-5 may be implemented in the form of hardware, firmware, or software. If implemented in software, the software may be any suitable form of software that can be stored on any form of machine-readable medium and loaded and executed by at least one general purpose or application specific processor.

What is claimed is:

1. A method for automatically configuring a Network Interface Device (NID), comprising:
enabling automatic detection of communications on at least one of multiple service ports of a Network Interface Device (NID);
configuring at least one of the multiple service ports based on a detection of communications; and
informing a supervisory unit external from the NID of at least one of the multiple service ports on which the communications are detected.

2. The method according to claim 1 further including activating a timer in response to the detection of communications, wherein informing the supervisory unit includes informing the supervisory unit in response to the timer reaching a terminal count.

3. The method according to claim 2 further including setting a timer value in non-volatile memory of the NID, the timer value corresponding to a length of time sufficient to install the NID in a network.

4. The method according to claim 2 further including updating a timer value at the supervisory unit, the timer value corresponding to a length of time sufficient to install the NID in a network.

5. The method according to claim 1 wherein informing the supervisory unit includes informing the supervisory unit through an existing communications protocol between the supervisory unit and the NID via a network communications port.

6. The method according to claim 1 further including enabling the multiple service ports.

7. The method according to claim 6 wherein configuring at least one of the multiple service ports includes disabling the multiple service ports except the at least one of the multiple service ports on which communications are detected.

8. The method according to claim 7 further including activating a timer in response to the detection of communications, wherein disabling the multiple service ports includes disabling the multiple service ports in response to the timer reaching a terminal count.

9. The method according to claim 6 wherein configuring at least one of the multiple service ports includes maintaining the multiple service ports in an enabled state.

10. The method according to claim 7 further including:
detecting communications inactivity on an enabled service port; and
re-enabling automatic detection of communications on at least one of the multiple service ports of the NID in response to detecting the communications inactivity.

11. The method according to claim 10 further including activating a timer in response to detecting the communications inactivity, wherein re-enabling detection of communications includes re-enabling detection of communications in response to the timer reaching a terminal count.

12. The method according to claim 1 wherein informing the supervisory unit includes informing an Optical Line Terminal (OLT).

13. The method according to claim 1 wherein informing the supervisory unit includes informing a management system.

14. A communications network, comprising:
a Network Interface Device (NID) including multiple service ports, an enabling unit, a configuration unit, and a reporting unit, the enabling unit configured to enable automatic detection of communications on at least one of the multiple service ports, the configuration unit configured to configure at least one of the multiple service ports based on a detection of communications; and
a supervisory unit in communication with and external from the NID, the reporting unit configured to inform the supervisory unit of at least one of the multiple service ports on which the communications are detected.

15. The communications network according to claim 14 wherein the NID further includes a timer that is activated in response to the detection of communications, the reporting unit further configured to inform the supervisory unit in response to the timer reaching a terminal count.

16. The communications network according to claim 15 wherein the NID further includes non-volatile memory configured to store a timer value corresponding to a length of time sufficient to install the NID in a network.

17. The communications network according to claim 15 wherein the supervisory unit includes a database configured to be updated with a timer value corresponding to a length of time sufficient to install the NID in a network.

18. The communications network according to claim 14 wherein the NID further includes a network communications port and the reporting unit is further configured to inform the supervisory unit through an existing communications protocol between the supervisory unit and the NID via the network communications port.

19. The communications network according to claim 14 wherein the enabling unit is further configured to enable the multiple service ports.

20. The communications network according to claim 19 wherein the NID further includes a disabling unit configured to disable the multiple service ports except the at least one of the multiple service ports on which communications are detected.

21. The communications network according to claim 20 wherein the NID further includes a timer that is activated in response to the detection of communications and the disabling unit is further configured to disable the multiple service ports in response to the timer reaching a terminal count.

22. The communications network according to claim 18 wherein the configuration unit is further configured to maintain the multiple service ports in an enabled state.

23. The communications network according to claim 14 wherein the enabling unit is further configured to re-enable automatic detection of communications on at least one of the multiple service ports in response to the detection of communications inactivity on at least one of the multiple service ports.

24. The communications network according to claim 23 wherein the NID further includes a timer that is activated in response to the detection of communications inactivity and the enabling unit is further configured to re-enable detection of communications in response to the timer reaching a terminal count.

25. The communications network according to claim 14 wherein the supervisory unit includes an Optical Line Terminal (OLT).

26. The communications network according to claim 14 wherein the supervisory unit includes a management system.

27. A computer-readable medium having stored thereon sequences of instructions, the sequences of instructions including instructions, when executed by a digital processor, that cause the processor to perform:
enabling automatic detection of communications on at least one of multiple service ports of a Network Interface Device (NID);
configuring at least one of the multiple service ports based on a detection of communications; and
informing a supervisory unit external from the NID of at least one of the multiple service ports on which the communications are detected.
